(19) United States
(12) Patent Application Publication
(10) Pub. No.: US 2018/0217636 A1
(43) Pub. Date: Aug. 2, 2018

(54) Docking Station or Device

(71) Applicant: Clint Brian McNamara, New South Wales (AU)

(72) Inventor: Clint Brian McNamara, New South Wales (AU)

(21) Appl. No.: 15/879,081

(22) Filed: Jan. 24, 2018

(30) Foreign Application Priority Data
Jan. 24, 2017 (AU) 2017900209

(51) Int. Cl. G06F 1/16; H01R 33/97; F16M 13/02; F16B 2/12

(52) U.S. Cl. CPC G06F 1/1632; H01R 33/97; F16M 2200/06; F16B 2/12; F16M 2200/024; F16M 13/022

(57) ABSTRACT

A docking station for supporting a mobile device, the device having a first connector for conducting electricity and attaching the mobile device to a platform. The docking station comprising a mounting member for releasably securing on an edge of the platform and a support member comprising a second connector for conducting electricity. A first rotatable joint engaging with the mounting member and the support member such that the first rotatable joint, and the support member are adapted to rotate around the mounting member on a horizontal plane when that mounting member engages platform while maintaining electrical conductivity between the first connector and second connector.

### TECHNICAL FIELD

The invention relates to a mobile device dock or a docking station or a device adapted to mount a mobile smart device including mobile phones, cell phones or computing tablets. In particular, the present invention relates to a charging apparatus or device adapted to mount on a platform for docking a mobile device.

### BACKGROUND

Mobile devices such as tablets, mobile phones, cell phones, smart watches, laptop, computing tablets, portable touchscreen personal computer, etc. are becoming smaller in size and lighter in weight. The thickness of such device is getting thinner and thinner and external support is required to keep the device in an upright position.

Some of these external supports also are known as a dock, docking station, port replicator, or cradle, and they all have a data and charging connector integrated therein. When a mobile device fit on the docking station, it can engage with the data and/or charging connector for charging the battery of the mobile device and/or provide data communication.

Typically, docking stations seat on a flat surface providing a stationary stand for supporting mobile devices in an upright position, and connecting charging and/or data communication cables. This arrangement provides an organised way to manage power and data communication cables of the mobile device.

Traditionally, docking station does not provide any facility to allow a mobile device altering its upright position. Also, the docking usually occupies a large area on the supporting surface of a platform such as a table, or bench. It will be beneficial to allow a mobile device to move away from the supporting surface of a platform when not in use.

In another kind of support for holding a mobile device, the support provided flexible neck and/or ball joint socket to allow the support of the mobile device to move around. However, these supports do not provide any integrated charging and/or data communication connector. The mobile device mounted on this kind of support require an independent connecting cable for charging and/or data communication. When the mobile device moves around, the charging and/or data communication cables have to follow. Hence the length and flexibility of the cable will constrain the movement of the mobile device. The turning and rotation of the mobile device may tie knots on the cable or pull the connector out of the mobile device.

Prior art document U.S. Pat. No. 7,918,427 disclosed a computer dock station includes a bracket covered with a cover member and having a fence at one side and upright pivot pins on the inside, and a locking mechanism, which includes a motive member, two follower members pivoted to the two opposite ends of the motive member and respectively coupled with the respective sliding slot to the upright pivot pins, two clamps respectively mounted on the follower members outside the bracket, and a screw rod threaded through the motive member and pivoted to the bracket and rotatable to move the motive member and to further turn the follower members about the respective upright pivot pins for adjusting the position of the clamps. This docking station does not provide any charging and/or data communication facility to connect with the computer.

U.S. Pat. No. 7,808,779 disclosed a portable device docking system, comprising: an elongate base and a device support arm. The elongate base has a flat top end, a lateral axis and a longitudinal axis perpendicular thereto, the flat top end defining an access slot. The device support arm adapted to be rotatably mounted to the elongate base along the longitudinal axis thereof and having a first position and a second position, the device support arm being defined by a first arm segment substantially concealing the access slot in the first position. However, this prior art can only provide very limited movement for the mobile device. The base of this prior art also occupies a large amount of space on a platform.

US Patent Application No. 20140168884 disclosed a docking station for a tablet device, comprising a frame portion, and a pedestal portion. The frame portion is adapted to retaining the tablet device. The frame portion is surrounding the tablet device and carrying a first universal adaptor for electrically coupling the tablet device to the frame portion. The pedestal portion is adapted to resting on a surface and the pedestal portion has a connecting head portion for releasably connecting the frame portion to the pedestal portion. Further, the connecting head portion carries a second universal adaptor for electrically coupling the head portion to the first universal adaptor when the frame portion is connected to the pedestal portion. This prior art is merely sitting on the table but not securable on the table. Further, the device takes up a lot of space on the table.

The present invention is substantially divergent in design elements from the prior art, and consequently it is clear that there is a need in the art for an alternative docking station for a mobile device.

Any discussion of the prior art throughout the specification should in no way be considered as an admission that such prior art is widely known or forms part of common general knowledge in the field.

### SUMMARY

It is therefore an object of the present invention to provide a new and novel docking system for a mobile device that is safe, ergonomically user-friendly and has heretofore not been utilized.

An alternative object of the present invention is to provide a docking system for a mobile device that is cost-effective and economical to manufacture, market and sell.

Other objects and advantages will become apparent when taken into consideration with the following specification and drawings.

It is also an object of the present invention to overcome or ameliorate at least one of the disadvantages of the prior art, or to provide a useful alternative.

It is a first aspect of the present invention to provide:

A docking station for supporting a mobile device having a first connector for conducting electricity, comprising:

a mounting member for releasably securing on an edge of a platform;

a support member comprising a second connector for conducting electricity;

a rotatable joint engaging with the mounting member and the support member such that the rotatable joint and support member can rotate around a horizontal plane while maintaining electrical conductivity between the first connector and second connector.

Preferably, the mounting member comprises a first jaw member for engaging a first surface of the platform and a second jaw member for engaging a second surface of the platform such that the first jaw and second jaw exert an inward pressure to secure the mounting member on the platform.

Preferably, the mounting member comprises a frame member, wherein the first jaw is fixed to one end of the frame member, and the second jaw is displaceable longitudinally relative to the first jaw.

Preferably, the frame comprises an elongate member for retaining the second jaw.

Preferably, the mounting member comprises a resilient means for pushing the first jaw towards the second jaw.

Preferably, the resilient means is fit around the elongated member such that the longitudinal axis of the resilient means is parallel to that of the elongate member.

Preferably, the elongate member is a screw shaft.

Preferably, the rotatable joint comprises a base member for engaging with one end of the mounting member such that the base member is rotatable around a longitudinal axis of the mounting member.

Preferably, the base member is rotatably engaged with the mounting member through a concentric joint.

Preferably, the rotatable joint comprising an arm connecting to the base member and the support member.

Preferably, the arm has one end rotatably connects to an outer side of the base member such that an axis of rotation of the base member is orthogonal to an axis of rotation of the arm around the base member.

Preferably, the arm has another end rotatably connects to the support member such that the axis of rotation of the arm around the base member is parallel to the axis of rotation of the support member around the arm.

Preferably, the rotatable joint has a releasable locking means to prevent any movement of the joint relative to the mounting member and the support member.

Preferably, the locking means comprises a first releasable lock for restraining the arm from rotating around the base member.

Preferably, the locking means comprises a second releasable lock for restraining the support member from rotating around the arm.

Preferably, the arm comprises a first hinge joint having a set of teeth disposed thereon for engaging another set of teeth disposed on a hinge joint of the support member.

Preferably, the arm comprises a second hinge joint having a set of teeth disposed thereon for engaging another set of teeth disposed on a hinge joint of the base member.

Preferably, the supporting member comprises a frame for releasably securing a mobile device thereon.

Preferably, the supporting member comprises a pad surface for supporting a mobile device thereon.

Preferably, the docking station further comprises a power connector for connecting to a power source.

Preferably, the power source comprises a battery.

Preferably, the docking station further comprises a compartment for housing the power source.

Preferably, the compartment comprises a lock for securing contents therein.

### BRIEF DESCRIPTION OF THE FIGURES

FIG. 1 is a schematic view of a docking station according to a first preferred embodiment of the present invention;

FIG. 2 is an schematic isometric view of an mounting member of the docking station o FIG. 1;

FIG. 3 is an front view of the mounting member of FIG. 2;

FIG. 4 is a schematic view of a docking station according to a second embodiment of the present invention;

FIG. 5 is another schematic view of a docking station of FIG. 4;

FIG. 6 is another schematic view of a docking station of FIG. 4;

FIG. 7 is a schematic view of a docking station according to a third preferred embodiment of the present invention;

FIG. 8 is another schematic view of a docking station of FIG. 7;

FIG. 9 is another schematic view of a docking station of FIG. 7; and

FIG. 10 is another schematic view of a docking station of FIG. 7.

### DESCRIPTION OF THE INVENTION

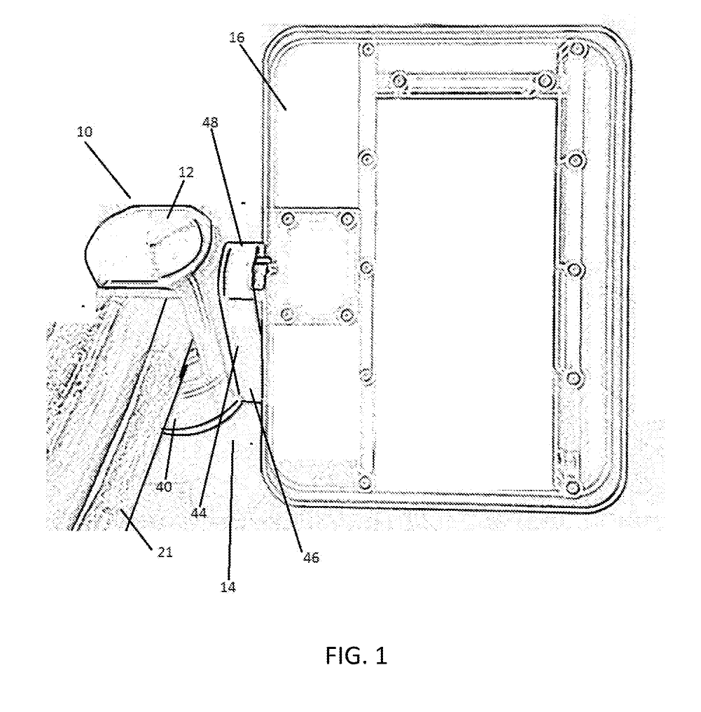

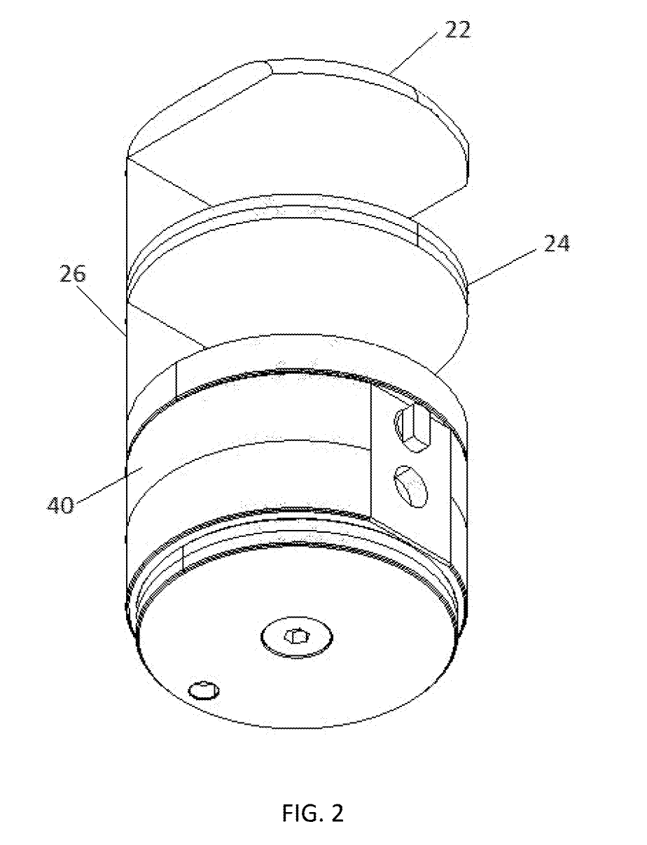

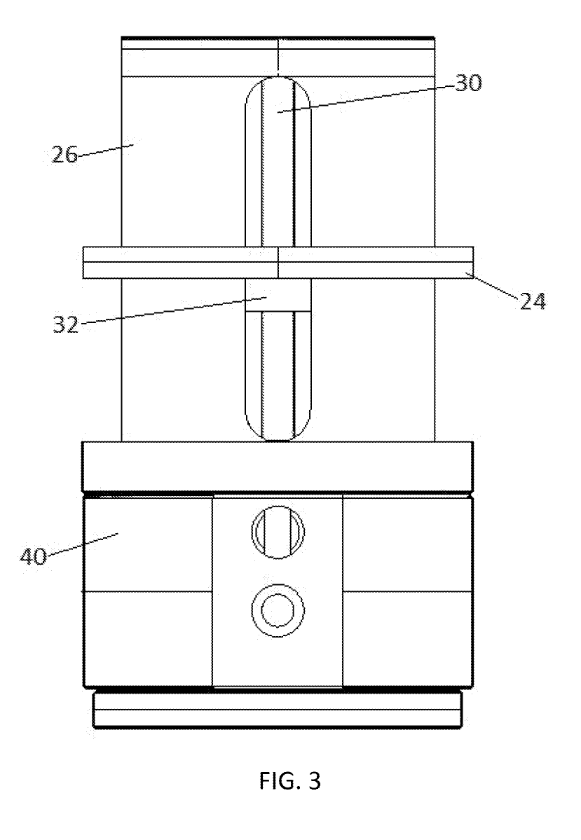

Referring to FIGS. 1 to 3, a first embodiment of the present invention provides a docking station 10 or device for supporting a mobile device having a first connector for conducting electricity, comprising a mounting member 12, a support member 16, and a rotatable joint 14.

The mounting member 12 is adapted to be releasably securing on an edge of a platform 21, such as a table, a book shelf, a bench, etc.

In one embodiment, the mounting member 12 comprises a C-Clamp or G-Clamp comprising a first jaw member 22 for engaging a first surface of the platform 21 and a second jaw member 24 for engaging a second surface of the platform such that the first jaw and second jaw exert an inward pressure to secure the mounting member on the platform.

The mounting member comprises a frame member 26, wherein the first jaw 22 is fixed to one end of the frame member. In one embodiment, the frame member 26 have a cylindrical shape as shown in FIGS. 1 to 3.

In the inside of the frame member 26, there is provided a groove for securing an elongate member 30. This elongate member 30 provide a guide for fitting into a ring 32 of the second jaw 24 such that the elongate member retains the freedom of movement of the second jaw. Hence the second jaw 24 is displaceable longitudinally relative to the first jaw.

In another embodiment, the elongate member is a screw shaft and by rotating the screw shaft, the second jaw 24 is cable of moving along the screw shaft.

In one embodiment, the mounting member comprises a resilient means such as a spring for pushing the first jaw 22 towards the second jaw 24. The elongate member 28 can fit into the spring such that the longitudinal axis of the spring is parallel to that of the elongate member.

In an alternative embodiment, the mounting member 12 comprises a clip for clipping the docking station 10 on the platform 21. In yet another embodiment the mounting member 12 comprises a mounting bracket or hook for mounting on the platform 21. However, in another embodiment, the mounting can be permanent by securing the docking station on the platform by screws, nut and bolts and other securing means.

The docking station 10 of the present invention further comprises a support member 16 for holding a mobile device such as mobile phone, tablet or surface PC. The support member 16 has a frame for releasably securing to a mobile device. In one embodiment, the frame is a bracket adapted for the mobile device to fitting snuggly thereon. In another embodiment, the frame is in the form of a sleeve to accommodate the mobile device, wherein the sleeve has a window for accessing the touch screen of the mobile device. The sleeve can be made of natural or artificial fabric. In a further embodiment, the frame provides a case for receiving the mobile device. The case comprises a window for accessing the touch screen of the mobile device. In one embodiment, the window has a thin membrane for protecting the touch screen from scratching. The case may be lockable such the mobile device is secured inside.

In another embodiment, the support member 16 comprises a pad surface for supporting a mobile device thereon. There is mobile device secured on the surface of the support member 16. The pad provides a soft surface to place the mobile device and other miscellaneous items like wallet, keys etc.

On the support member 16, there is provide an electricity connector for connecting to the mobile device. The electric connector on the support member 16 can use to charge the mobile device. In another embodiment, the electric connector of the support member 16 can allow data communication to a server.

In another embodiment, there is no electric connector installed on the support member 16. The support member 16 provide a near field charging device for charging the mobile device through electromagnetic induction. The support member 16 may also have a near field communication device for transferring data to and from the mobile device.

The rotatable joint 14 may comprise a number of moving parts depending on the degrees of freedom of movement required to provide for the mobile device. In one embedment, there is provided a docking station 10 which has the capabilities of locking onto a surface area of a platform 21 with the mobile device hanging over the docking station. The rotatable joint 14 provides the capabilities of going in, under and on top of the platform 21.

This docking station 10 may be installed to a master area of a kitchen, a bar where the consumer will be able to order & pay for meals, drinks directly to the point of distribution where underneath holds the docking station for a mobile device. When making an order, the customer may move the mobile device to make an order. Once it is finished, the mobile device may move back under the table to provide more space for the table.

Therefore, the rotatable joint 14 engages with the mounting member 12 and the support member 16 such that the rotatable joint, and support member can rotate around a horizontal plane while maintaining electrical conductivity between the first connector and second connector. In this way, the support member 16 may flip down to a horizontal position and rotate under the platform 21.

In one embodiment, the rotatable joint 14 comprises a base member 40 for engaging with one end of the mounting member such that the base member is rotatable around a longitudinal axis of the mounting member. The base member 40 is rotatably engaged with the mounting member through a concentric joint.

The rotatable joint 14 further comprises an arm 44 connecting to the base member 40 and the support member 16. The arm 14 has one end 46 rotatably connects to an outer side of the base member 40 such that an axis of rotation of the base member is orthogonal to an axis of rotation of the arm around the base member. The arm 44 has another end 48 rotatably connects to the support member 16 such that the axis of rotation of the arm around the base member is parallel to the axis of rotation of the support member around the arm.

The rotatable joint 14 has a releasable locking means to prevent any movement of the joint relative to the mounting member 12 and the support member 16. The locking means has a first releasable lock for restraining the arm 44 from rotating around the base member 40 and the locking means comprises a second releasable lock for restraining the support member 16 from rotating around the arm.

In one embodiment, the arm 44 comprises a first hinge joint having a set of teeth disposed thereon for engaging another set of teeth disposed on a hinge joint of the support member and the arm 44 comprises a second hinge joint having a set of teeth disposed thereon for engaging another set of teeth disposed on a hinge joint of the base member.

In another embodiment, the arm 44 comprises a first elongate member insert inside a second elongate member such that they can displace telescopically to provide an adjustable length to the arm.

In one embodiment, the docking station comprises a power connector for connecting to a power source. A power cord may run into the frame member 26. Inside frame member 26, there is an electricity conductor running through the centre of joint rotatable to the base member 40 such that the revolution of the base member 40 will not twist the electricity conductor. The electric conductor may further run into the arm 44 through the centre of the hinge connecting the base member 40 and the arm and hence movement of the arm will not twist the electricity conductor. The electricity conductor may then run into the support member 16 through the hinge between the arm 44 and the support member 16 and terminated in the electricity connector for charging the mobile device.

In one embodiment, the support member 16 comprise a locking mechanism for securing the mobile device or power source on the support member.

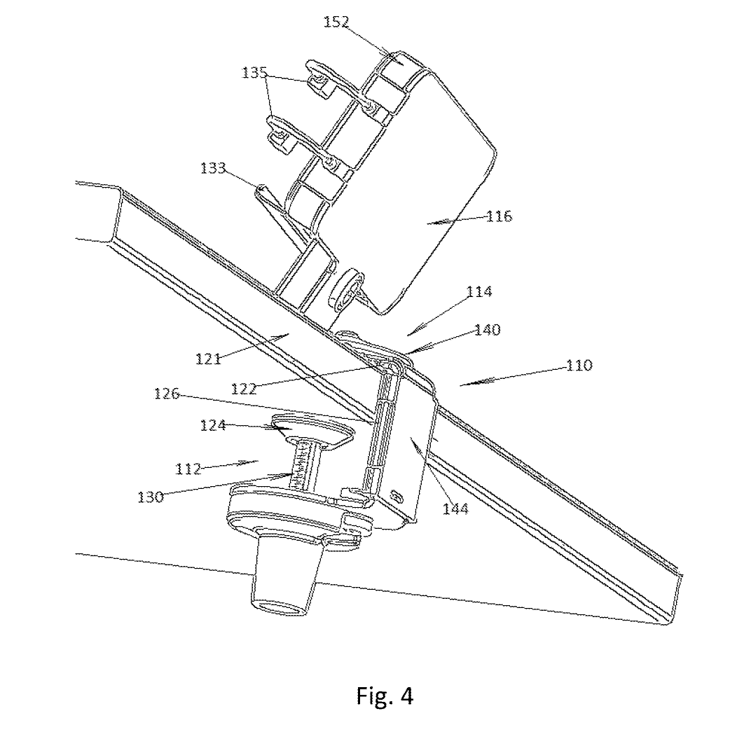

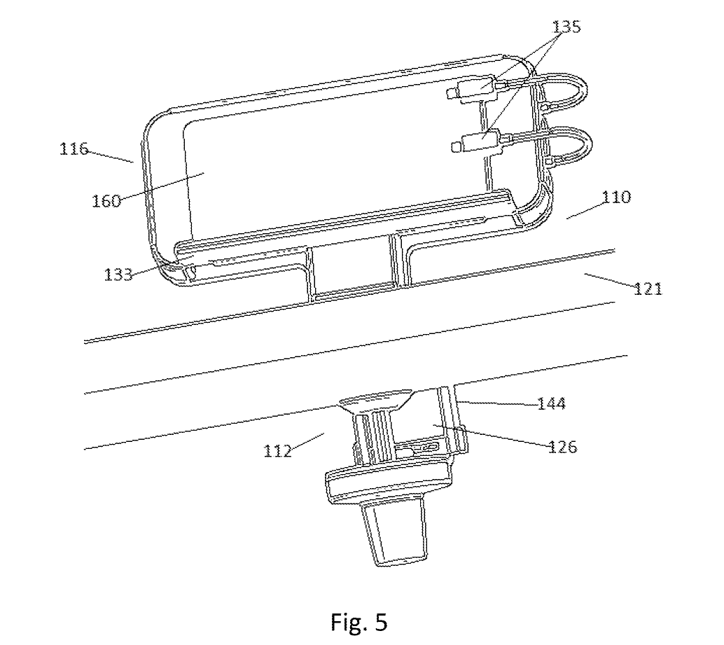

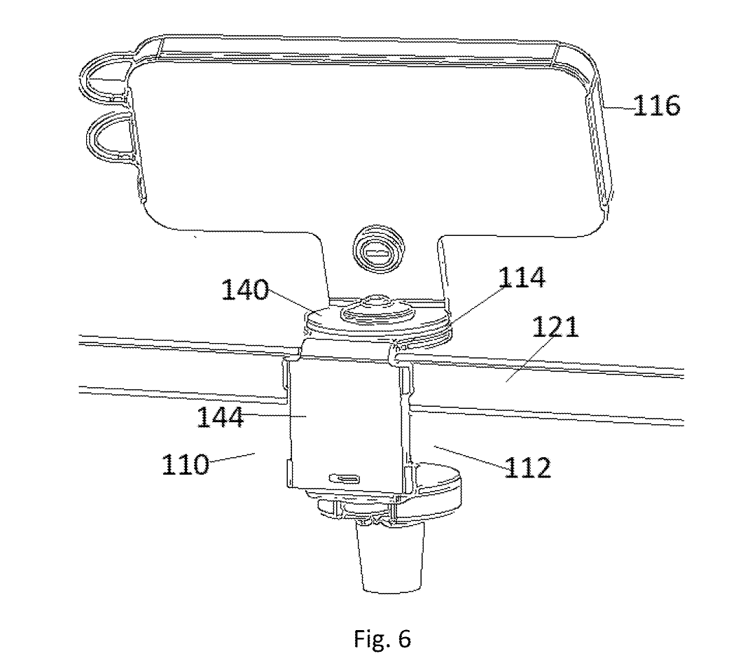

Referring to FIGS. 4 to 6, a second embodiment of the present invention provides a docking station 110 or device for supporting a mobile device having a first connector for conducting electricity, comprising a mounting member 112, a support member 116. In one embodiment, the docking station 110 further comprise a rotatable joint 114.

The mounting member 112 is adapted to be releasably securing on an edge of a platform 121, such as a table, a book shelf, a bench, etc.

In another embodiment as shown in FIGS. 4 to 6, the mounting member 112 comprises a C-Clamp or G-Clamp comprising a first jaw member 122 for engaging a first surface of the platform 121 and a second jaw member 124 for engaging a second surface of the platform such that the first jaw and second jaw exert an inward pressure to secure the mounting member on the platform.

The mounting member comprises a frame member 126, wherein the first jaw 122 is fixed to one end of the frame member. In one embodiment, the frame member 126 have a cylindrical shape as shown in FIGS. 4 to 6.

In the inside of the frame member 126, there is provided a base for accommodating an elongate member 130. This elongate member 130 has one end attached to the second jaw 124 such that the elongate member control the longitudinal movement of the second jaw. Hence the second jaw 124 is displaceable longitudinally relative to the first jaw 122.

In the embodiment as shown in FIGS. 4 to 6, the elongate member 130 is a screw shaft and by rotating the screw shaft, the second jaw 124 can be displaced upwardly or downward relative to the frame member 126.

As shown in FIGS. 4 to 6, the docking station 110 of the present invention further comprises a support member 116 for holding a mobile device such as mobile phone, tablet or surface PC. The support member 116 has a frame 152 for releasably securing to a mobile device. In one embodiment, the frame 152 is a bracket adapted for the mobile device to fitting snuggly thereon.

In another embodiment, the frame 152 is in the form of a sleeve to accommodate the mobile device, wherein the sleeve has a window for accessing the touch screen of the mobile device. The sleeve can be made of natural or artificial fabric. In a further embodiment, the frame 152 provides a case for receiving the mobile device. The case comprises a window for accessing the touch screen of the mobile device. In one embodiment, the window has a thin membrane for protecting the touch screen from scratching. The case may be lockable such the mobile device is secured inside.

In another embodiment, the support member 116 comprises a pad surface for supporting a mobile device thereon. There is mobile device secured on the surface of the support member 116. The pad provides a soft surface to place the mobile device and other miscellaneous items like wallet, keys etc.

In one embodiment as shown in FIGS. 4 to 6, the support member 116 comprises a supporting tray 133 for holding different items such as a tablet, notebook, papers, mobile phone, etc.

One or more charging electricity connectors 135 are provided in a preferred embodiment. The electric connectors 135 on the support member 116 can use to charge the mobile device. In another embodiment, the electric connectors 135 of the support member 116 can allow data communication to a server.

In another embodiment, there is no electric connector installed on the support member 116. The support member 116 provide a power source 160, such as wireless or near field charging device for charging the mobile device through electromagnetic induction. The support member 16 may also have a near field communication device for transferring data to and from the mobile device. In another embodiment, the supporting member 116 is adapted to provide an electric connector associated with a power source 160, such as an uninterrupted power supply.

In one embodiment, the frame 152 of the supporting member 116 is adapted to accommodate a power source for supplying power to the mobile device supporting on the supporting tray 133. The power source can be a wireless or near field charger, an uninterrupted power supply, or a transformer, etc.

The rotatable joint 114 may comprise a number of moving parts depending on the degrees of freedom of movement required to provide for the mobile device. In one embedment, there is provided a docking station 110 which has the capabilities of locking onto a surface area of a platform 121 with the mobile device hanging over the docking station.

The rotatable joint 114 engages with the mounting member 112 and the support member 116 such that the rotatable joint, and support member can rotate around a horizontal plane while maintaining electrical conductivity between a first connector and a second connector.

In one embodiment, the rotatable joint 114 comprises a base member 140 for engaging with one end of the mounting member 112 such that the base member is rotatable around a longitudinal axis of the mounting member. The base member 140 is rotatably engaged with the mounting member through a concentric joint.

In one embodiment, the rotatable joint 114 further comprises an arm connecting to the base member 140 and the support member 116. The arm is adapted to allow the support member 116 around a plane parallel to the longitudinal axis of the mounting member 112.

Preferably, the rotatable joint 114 has a releasable locking means to prevent any excessive movement of the joint relative to the mounting member 112 and the support member 116.

In one embodiment, the arm 144 comprises a hinge joint having a set of teeth disposed thereon for engaging another set of teeth disposed on a hinge joint of the mounting member 112.

In another embodiment, the arm 144 comprises a first elongate member insert inside a second elongate member such that they can displace telescopically to provide an adjustable length to the arm.

In one embodiment, the support member 116 comprise a locking mechanism for securing the mobile device or power source on the support member.

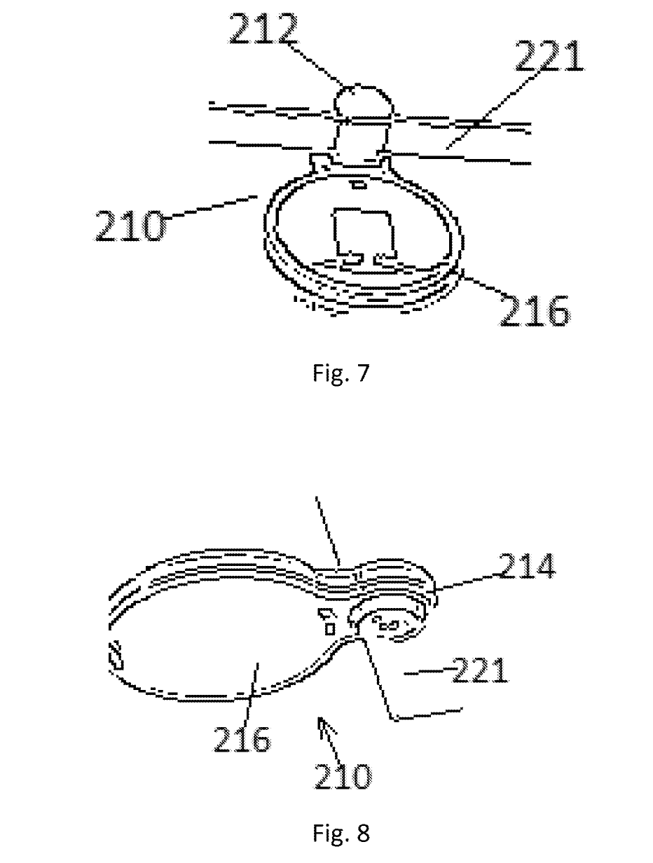

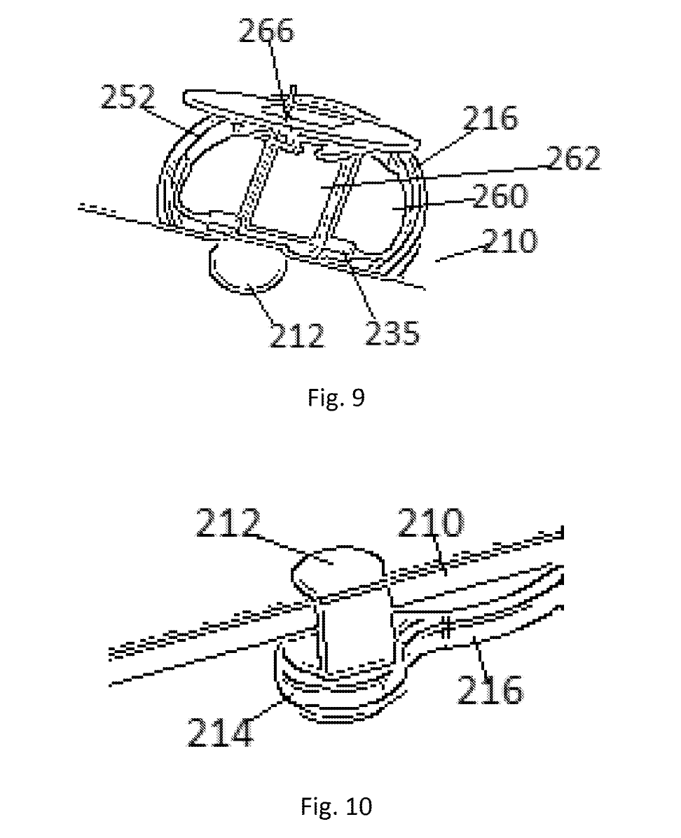

Referring to FIGS. 7 to 10, a second embodiment of the present invention provides a docking station 210 or device for supporting a mobile device having a first connector for conducting electricity, comprising a mounting member 212, a support member 216. In one embodiment, the docking station 210 further comprise a rotatable joint 214.

The mounting member 212 is adapted to be releasably securing on an edge of a platform 221, such as a table, a book shelf, a bench, etc.

In yet another embodiment as shown in FIGS. 7 to 10, the mounting member 212 similar to those described about such as the mounting member 12 or mounting member 112. In one embodiment as shown in FIGS. 7 to 10, the mounting member 212 comprises bias means for engaging a platform 221 through a resilient force exerting upon the platform. In a preferred embodiment, the bias means is a metal clip as shown in FIGS. 7 to 9.

As shown in FIGS. 7 to 10, the docking station 110 of the present invention further comprises a support member 216 for holding a mobile device such as mobile phone, tablet or surface PC. The support member 216 has a frame 252 for releasably securing to a mobile device.

One or more charging electricity connectors 235 are provided in a preferred embodiment. The electric connectors 235 on the support member 216 can use to charge the mobile device. In another embodiment, the electric connectors 235 of the support member 216 can allow data communication to a server.

In another embodiment, there is no electric connector installed on the support member 216. The support member 216 provide a power source 262 such as a battery or wireless or near field charging device for charging the mobile device through electromagnetic induction. The support member 216 may also have a near field communication device for transferring data to and from the mobile device. In another embodiment, the supporting member 216 is adapted to provide an electric connector associated with a power source 262, such as an uninterrupted power supply.

In one embodiment, the frame 252 of the supporting member 216 comprises a compartment 260 for accommodating a power source 262 for supplying power to the mobile device. The power source can be a wireless or near field charger, an uninterrupted power supply, or a transformer, etc. In a preferred embodiment, the electricity connectors 236 is connected directly to the power source 262.

In a preferred embodiment, the support member 212 comprises a rotatable joint 214. The rotatable joint 214 may comprise a number of moving parts depending on the degrees of freedom of movement required to provide for the mobile device.

The rotatable joint 214 engages with the mounting member 212 and the support member 216 such that the rotatable joint, and support member can rotate around a horizontal plane.

Preferably, the rotatable joint 214 has a releasable locking means to prevent any excessive movement of the joint relative to the mounting member 212 and the support member 216.

In one embodiment, the support member 216 comprise a locking mechanism 266 for securing the mobile device or power source 262 on the support member.

In another aspect of the invention, there is provided a self-charging wrist band having a solar panel strip in the band which charges a small battery on the band. A user may pull the band apart and on one side there is provided a USB connector and the other side a connector for connecting with a mobile device. The USB connector allows a user to charge the device not using solar energy and obtaining the source within the rubber wrist band.

In one preferred embodiment, the docking station is made of recyclable material.

Although the invention has been described with reference to specific examples, it will be appreciated by those skilled in the art that the invention may be embodied in many other forms, in keeping with the broad principles and the spirit of the invention described herein.

The present invention and the described embodiments specifically include the best method known to the applicant of performing the invention. The present invention and the described preferred embodiments specifically include at least one feature that is industrial applicable.

1. A docking station for supporting a mobile device having a first connector for conducting electricity and attaching the mobile device to a platform, comprising:
a mounting member for releasably securing on an edge of the platform;
a support member comprising a second connector for conducting electricity;
a first rotatable joint engaging with the mounting member and the support member such that the first rotatable joint, and the support member are adapted to rotate around the mounting member on a horizontal plane when that mounting member engages platform while maintaining electrical conductivity between the first connector and second connector.

2. A docking station according to claim 1, wherein the mounting member comprises a first jaw member for engaging a first surface of the platform and a second jaw member for engaging a second surface of the platform such that the first jaw and second jaw exert an inward pressure to secure the mounting member on the platform.

3. A docking station according to claim 2, wherein the mounting member comprises a frame member, wherein the first jaw is fixed to one end of the frame member, and the second jaw is displaceable longitudinally relative to the first jaw.

4. A docking station according to claim 3, wherein the frame comprises an elongate member for retaining the second jaw.

5. A docking station according to claim 4, wherein the mounting member comprises a resilient means for compressing the first jaw towards the second jaw.

6. A docking station according to claim 5, wherein the elongate member is adapted to insert inside the resilient means such that the longitudinal axis of the resilient means is parallel to that of the elongate member.

7. A docking station according to claim 4, wherein the elongate member is a screw shaft.

8. A docking station according to claim 1, wherein the rotatable joint comprises a base member for engaging with one end of the mounting member such that the base member is rotatable around a longitudinal axis of the mounting member.

9. A docking station according to claim 8, wherein the base member is adapted to rotatably engaged with the mounting member through a concentric joint.

10. A docking station according to claim 8, wherein the first rotatable joint comprising an arm connecting to the base member and the support member.

11. A docking station according to claim 10 wherein the arm comprises second rotatable joint adapted to engage an outer side of the base member such that an axis of rotation of the base member is orthogonal to an axis of rotation of the arm around the base member.

12. A docking station according to claim 11, wherein the second rotatable joint adapted to engage the support member such that the axis of rotation of the arm around the base member is parallel to the axis of rotation of the support member around the arm.

13. A docking station according to claim 1, wherein the first rotatable joint has a releasable locking means to prevent any movement of the joint relative to the mounting member and the support member.

14. A docking station according to claim 13, wherein the locking means comprises a first releasable lock for restraining the arm from rotating around the base member.

15. A docking station according to claim 13, wherein the locking means comprises a second releasable lock for restraining the support member from rotating around the arm.

16. A docking station according to claim 13, wherein the arm comprises a first hinge joint having a set of teeth disposed thereon for engaging another set of teeth disposed on a hinge joint of the support member.

17. A docking station according to claim 13, wherein the arm comprises a second hinge joint having a set of teeth disposed thereon for engaging another set of teeth disposed on a hinge joint of the base member.

18. A docking station according to claim 1, wherein the supporting member comprises a frame for releasably securing a mobile device thereon.

19. A docking station according to claim 1, wherein the supporting member comprises a pad surface for supporting a mobile device thereon.

20. A docking station according to claim 1, further comprising a power connector for connecting to a power source.

21. A docking station according to claim 21, wherein the power source comprises a battery.

22. A docking station according to claim 20, further comprising a compartment for housing the power source.

23. A docking station according to claim 22, wherein the compartment comprises a lock for securing contents therein.
